(19) United States
(12) Patent Application Publication
(10) Pub. No.: US 2010/0085771 A1
(43) Pub. Date: Apr. 8, 2010

(54) LIGHT GUIDING PLATE

(76) Inventor: Feng-Li LIN, Taishan Township (TW)

Correspondence Address: BIRCH STEWART KOLASCH & BIRCH, PO BOX 747, FALLS CHURCH, VA, 22040-0747, US

(21) Appl. No.: 12/571,837

(22) Filed: Oct. 1, 2009

(30) Foreign Application Priority Data
Oct. 3, 2008 (TW) 097138248

(51) Int. Cl. F21V 7/22

(52) U.S. Cl. 362/606; 362/620

(57) ABSTRACT

A light guiding plate includes a light guiding plate body and a plurality of total internal reflection destruction materials. The light guiding plate body has a first surface and a second surface opposite to the first surface. The first surface has a first microstructure array. The material of the total internal reflection destruction materials is different from the material of the light guiding body. The total internal reflection destruction materials are unevenly distributed on the first surface and/or the second surface.

### CROSS REFERENCE TO RELATED APPLICATIONS

This Non-provisional application claims priority under 35 U.S.C. §119(a) on Patent Application No(s). 097138248 filed in Taiwan, Republic of China on October 3, 2008, the entire contents of which are hereby incorporated by reference.

### BACKGROUND OF THE INVENTION

1. Field of Invention

The present invention relates to an optical sheet and, in particular, to a light guiding plate.

2. Related Art

According to the development of display technology, the traditional CRT display apparatuses are replaced by the LCD apparatuses recently. In practice, the LCD apparatuses have been applied to various kinds of electronic products such as notebook computers, televisions and desktop monitors.

In general, an LCD apparatus includes a backlight module and an LCD panel. Since the LCD panel can not emit light spontaneously, the backlight module is necessary to provide sufficient brightness and even light source for enabling the LCD panel to display images.

FIG. 1 is a schematic diagram showing a conventional backlight module 1, which is a side-edged type backlight module. As shown in FIG. 1, the backlight module 1 includes a light source 11, a reflective plate 12, a light guiding plate 13 and an optical film assembly 14.

The light source 11 is disposed adjacent to a lateral surface 131 of the light guiding plate 13, and the reflective plate 12 is disposed on a bottom surface 132 of the light guiding plate 13. Thus, the reflective plate 12 can reflect the light emitted out of the light guiding plate 13 through the bottom surface 132 back to the light guiding plate 13, so that the light utilization can be increased. The surface of the light guiding plate 13 facing the reflective plate 12 is usually configured with a plurality of dots 133, which are formed by printing white ink on the bottom surface 132 of the light guiding plate 13. The optical film assembly 14 is disposed on the light guiding plate 13 and is usually includes a lower diffuser 141, a brightness enhancement film 142 and an upper diffuser 143.

The light guiding plate 13 is commonly plate-shaped. The light emitted from the light source 11 can enter the light guiding plate 13 through the lateral surface 131 and then travel through the light guiding plate 13 to the other end thereof accompanying with total internal reflection. When the light reaches the dots 133, the total internal reflection of the traveling light can be destructed by scattering, so that the light can be scattered out of the light guiding plate 13 through a top surface 134. It is possible to obtain an evener surface light, which is emitted from the light source 11 and then outputted from the light guiding plate 13, by controlling the density of the dots 133. After passing through the optical film assembly 14, the light outputted from the light guiding plate 13 can be much more even.

In the prior art, the light guiding plate 13 is usually formed by injection molding. However, the size of the light-guiding plate 13 has sufficiently increased, so that the required injection pressure for the injection molding also increases, which results in the growth of the cost for manufacturing machines and processes.

Therefore, it is an important subjective to provide a light guiding plate, which has lower manufacturing cost and is capable of forming even surface light source.

### SUMMARY OF THE INVENTION

In view of the foregoing, the present invention is to provide a light guiding plate, which has lower manufacturing cost.

To achieve the above, the present invention discloses a light guiding plate including a light guiding plate body and a plurality of total internal reflection destruction materials. The light guiding plate body has a first surface and a second surface opposite to the first surface. The first surface has a first microstructure array. The material of the total internal reflection destruction materials is different from that of the light guiding body, and the total internal reflection destruction materials are unevenly distributed on the first surface and/or the second surface.

As mentioned above, the light guiding plate of the present invention has a first surface with the first microstructure array, and the materials of the light guiding plate body and the total internal reflection destruction materials are different. Compared with the prior art, the light guiding plate body of the present invention can be manufactured by the rolling process, so that the cost for manufacturing machines and processes can be reduced. Moreover, the light guiding plate of the present invention can be easily fabricated in mass production. In addition, the second surface of the light guiding plate body may further have a second microstructure array for further enhancing the uniformity of the outputted light. Furthermore, some of the total internal reflection destruction materials are light permeable, which facilitates the light refraction for forming the even surface light source.

### BRIEF DESCRIPTION OF THE DRAWINGS

The invention will become more fully understood from the detailed description and accompanying drawings, which are given for illustration only, and thus are not limitativc of the present invention, and wherein:

FIG. 1 is a schematic diagram showing a conventional backlight module;

FIG. 2 is a schematic diagram of a light guiding plate according to a first embodiment of the present invention;

FIG. 3 is a sectional view of the light guiding plate according to the first embodiment of the present invention;

FIG. 4 is a schematic diagram showing the process of fabricating the light guiding body according to the first embodiment of the present invention;

FIG. 5 is a schematic diagram of a light guiding plate according to a second embodiment of the present invention;

FIG. 6 is a sectional view of the light guiding plate along the line A-A of FIG. 5;

FIG. 7 is a schematic diagram showing the process of fabricating the light guiding body according to the second embodiment of the present invention;

FIG. 8 is a schematic diagram of a light guiding plate according to a third embodiment of the present invention;

FIG. 9 is a schematic diagram showing the process of fabricating the light guiding body according to the third embodiment of the present invention; and

FIG. 10 is a schematic diagram of a light guiding plate according to a fourth embodiment of the present invention.

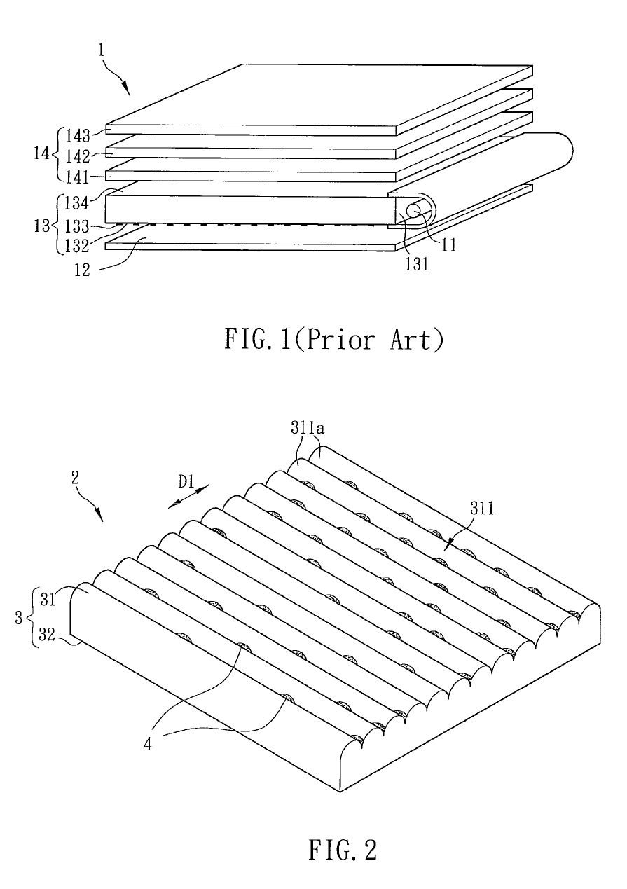

### DETAILED DESCRIPTION OF THE INVENTION

The present invention will be apparent from the following detailed description, which proceeds with reference to the accompanying drawings, wherein the same references relate to the same elements.

### First Embodiment

With reference to FIG. 2, a light guiding plate 2 according to a first embodiment of the present invention includes a light guiding plate body 3 and a plurality of total internal reflection destruction materials 4. In the embodiment, the light guiding plate 2 is used in a side-edged type backlight module for example.

The light guiding plate body 3 has a first surface 31 and a second surface 32 disposed opposite to each other. The first surface 31 has a first microstructure array 311, which may include prisms, convex lenses, lenticular lenses, concave lenses, Fresnel lenses, or their combinations. In this embodiment, the first microstructure array 311 includes a plurality of lenticular lenses 311a, which are arranged in an array. As shown in FIG. 2, the lenticular lenses 311a are arranged in parallel along a first direction D1, which means that the lenticular lenses 311a are arranged in one dimension.

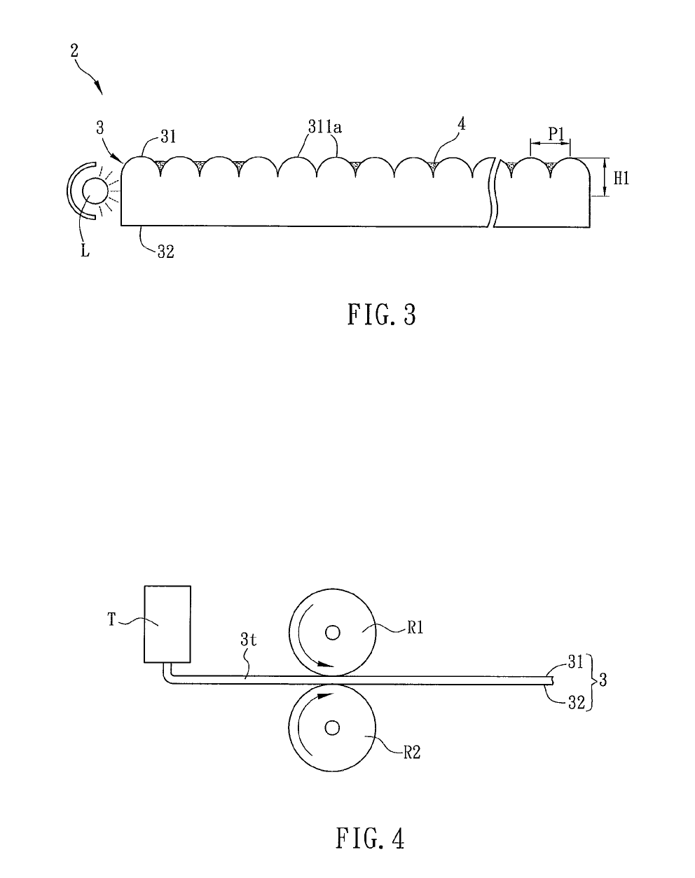

FIG. 3 is a sectional view of the light guiding plate 2 of FIG. 2. As shown in FIG. 3, the section of each lenticular lens 311a is arc-shaped. Of course, the section of the lenticular lens 311a may be semicircular or in other shapes. In this case, each lenticular lens 311a has a top point, and the distance P1 between two adjacent top points is ranged from 5 to 500 μm. In addition, each lenticular lens 311a has a height H1 ranged from 5 to 500 μm. Otherwise, the distance P1 and the height H1 may be not a constant value instead of a periodical variable value.

The total internal reflection destruction materials 4 are different from the material of the light guiding body 3 and are unevenly distributed on the first surface 31 and/or the second surface 32. In this embodiment, the total internal reflection destruction materials 4 are disposed on the first surface 31 for example. The light emitted from the light source L enters one end of the light guiding plate 2 and is than outputted from the light guiding plate 2 through the first surface 31. The positions of the total internal reflection destruction materials 4 are not limited, and they can be disposed on the convex portions of the lenticular lenses 311a or the concave portions between the lenticular lenses 311a. The shapes of the total internal reflection destruction materials 4 can be circular, elliptic, convex polygonal, concave polygonal, irregular or their combinations. In addition, the total internal reflection destruction materials 4 can be formed by mixing a transparent polymer material with a plurality of scattering particles. Of course, the total internal reflection destruction materials 4 can also be formed by white ink or other materials capable of changing the traveling direction of the light so as to destruct the total internal reflection. If the total internal reflection destruction materials 4 are formed by mixing a transparent polymer material with a plurality of scattering particles, the material of the scattering particles can be organic polymer or inorganic material such as PMMA (polymethyl methacrylate), TiO2, MgO2, SiO2, glass, BaSO4, or gas (e.g. air or inert gas). Since the total internal reflection destruction materials 4 contain the transparent polymer material, at least a part thereof is light permeable. Therefore, even if the total internal reflection destruction materials 4 are disposed on the light outputting surface of the light guiding plate body 3, they will not block all outputted light so as to keep the intensity of the outputted light.

To be noted, the total internal reflection destruction materials 4 contain the transparent polymer material and the scattering particles, so that the light, which is emitted from the light source L, and travels in the light guiding plate body 3 with several times of total internal reflection, and then reaches the transparent polymer material, can be refracted due to the different of the refraction indexes of the transparent polymer material and the light guiding plate body 3. Accordingly, the light traveling path can be changed and thus the total internal reflection can be destructed. When the light reaches the scattering particles, it can be scattered, which can also change the traveling path of the light so as to destruct the total internal reflection. These configurations can help the light guiding plate 2 to output the evener light.

In order to make the light outputted from the light guiding plate 2 become a surface light source, the distribution of the total internal reflection destruction materials 4 may be designed in accordance with the different aspects of the first microstructure array 311 of the light guiding plate 2. For example, the distribution density or area of the total internal reflection destruction materials 4 is smaller at the position closer to the light source L; otherwise, the distribution density or area of the total internal reflection destruction materials 4 is larger at the position far away from the light source L. By the non-evenly distributed total internal reflection destruction materials 4, the light traveling in the light guiding plate 2 can be scattered and then outputted evenly, so that the light guiding plate 2 can form a surface light source. In order to reach the non-even distribution and acceptable optical properties of the total internal reflection destruction materials 4, the total internal reflection destruction materials 4 are formed on the first surface 31 and/or the second surface 32 by sand blasting, printing or ink-jet printing. In practice, before utilizing the printing or sand blasting to form the total internal reflection destruction materials 4, a plate or mesh plate with predetermined pattern is prepared. Then, the transparent polymer material mixed with the scattering particles is sand blasted or printed on the light guiding plate body 3 with passing through the plate or mesh plate. Consequently, the predetermined distribution of the transparent polymer material and the scattering particles, which is a non-even distribution, can be formed on the light guiding plate body 3. In this case, since the total internal reflection destruction materials 4 and the light guiding plate body 3 are separately formed, their materials can be different.

Hereinafter, the fabrication of the light guiding plate body 3 according to the first embodiment will be described with reference to FIG, 4.

The material of the light guiding plate body 3 is a transparent polymer material such as PC (polycarbonate), PMMA (polymethyl methacrylate), PET (polyethylene terephthalate), polystyrene, polyester, polyolefin, polyether, polyether-ester, polymethacrylate, or PEP (polyperfluorinated ethylene propylene). In this embodiment, the light guiding plate body 3 is made of a transparent polymer material such as PC (polycarbonate). In more detailed, the melted transparent polymer material 3t is firstly outputted from a tank T and then pressed by an embossed roller R1 with predetermined concave pattern and a planar roller R2. After a cooling process, the light guiding plate body 3 with a first surface 31 having the first microstructure array is obtained. The predetermined concave pattern of the embossed roller R1 may be changed in accordance with the desired shape of the first microstructure array. This can be simply reached by pre-forming a complementary shape of the first microstructure array on the embossed roller R1.

As mentioned above, the light guiding plate body 3 can be fabricated in mass production by the rolling process in cooperating with the roller R1 with the predetermined concave pattern and the planar roller R2. After a proper cutting process, the desired light guiding plate body 3 can be manufactured. Due to the limitation of the surface areas of the rollers R1 and R2, the pattern of the first microstructure array may periodically appear on the light guiding plate body 3. In addition, the rollers R1 and R2 used in the rolling process are cheaper and the modification of the pattern is easy (e.g. forming or modifying the pattern on the roller by laser engraving), so that the manufacturing cost of the light guiding plate 2 can be reduced.

### Second Embodiment

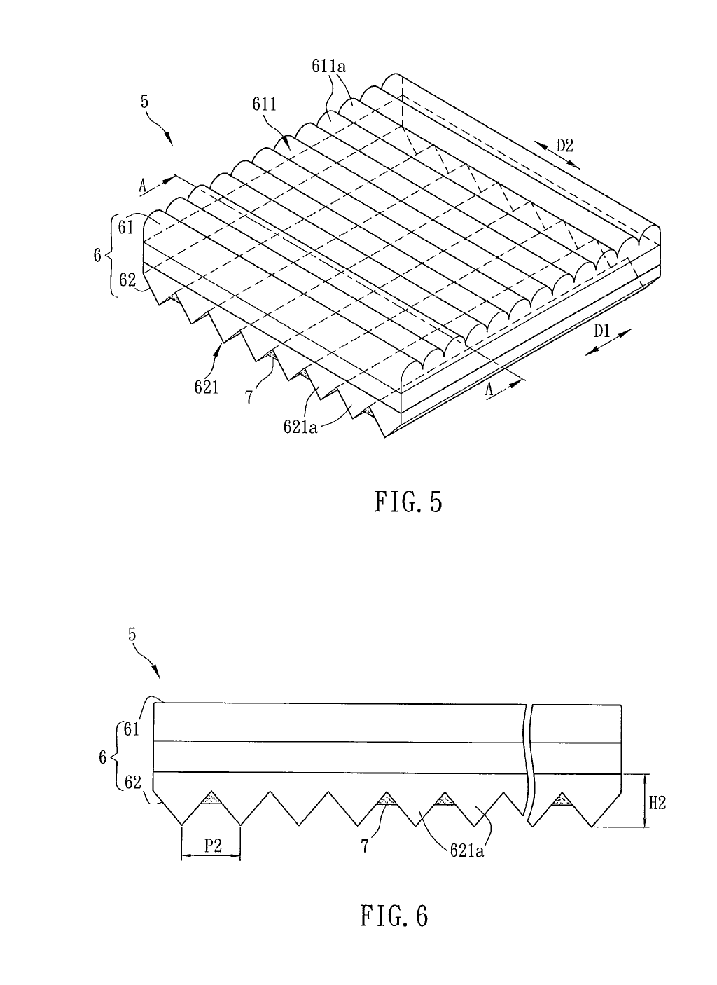

FIG. 5 is a schematic diagram of a light guiding plate 5 according to a second embodiment of the present invention, and FIG. 6 is a sectional view of the light guiding plate 5 along the line A-A of FIG. 5. As shown in FIGS. 5 and 6, the light guiding plate 5 includes a light guiding plate body 6 and a plurality of total internal reflection destruction materials 7.

The light guiding plate body 6 has a first surface 61 and a second surface 62 disposed opposite to each other. The first surface 61 has a first microstructure array 611, which includes a plurality of lenticular lenses 611a in this embodiment. As shown in FIG. 5, the lenticular lenses 611a are arranged in parallel along a first direction D1. The technical features of the first microstructure array 611 are the same as those of the first microstructure array 311 of the first embodiment, so the detailed descriptions thereof will be omitted.

The second surface 62 of the light guiding body 6 has a second microstructure array 621, which may include prisms, convex lenses, lenticular lenses, concave lenses, Fresnel lenses, or their combinations. In this embodiment, the second microstructure array 621 includes a plurality of prisms 621a, which are arranged in an array. As shown in FIG. 5, the prisms 621a are arranged in parallel along a second direction D2, which is perpendicular to the first direction D1. The sections of the prisms 621a can be triangular, trapezoid, irregular, or their combinations. In addition, each prism 621a has a top corner, and a distance P2 between two adjacent top corners is ranged from 5 to 500 μm, and each prism 621a has a height H2 ranged from 5 to 500 μm. Otherwise, the distance P2 and the height H2 may be not a constant value instead of a periodical variable value. To be noted, the sizes of the lenticular lenses 611a are not necessary to be correspondingly the same as those of the prisms 621a.

The total internal reflection destruction materials 7 can be disposed on the first surface 61 and/or the second surface 62. In the present embodiment, the total internal reflection destruction materials 7 are disposed on the second surface 62 for example. The formations and other technical features of the total internal reflection destruction materials 7 are the same as those of the total internal reflection destruction materials 4 of the first embodiment, so the detailed descriptions thereof will be omitted.

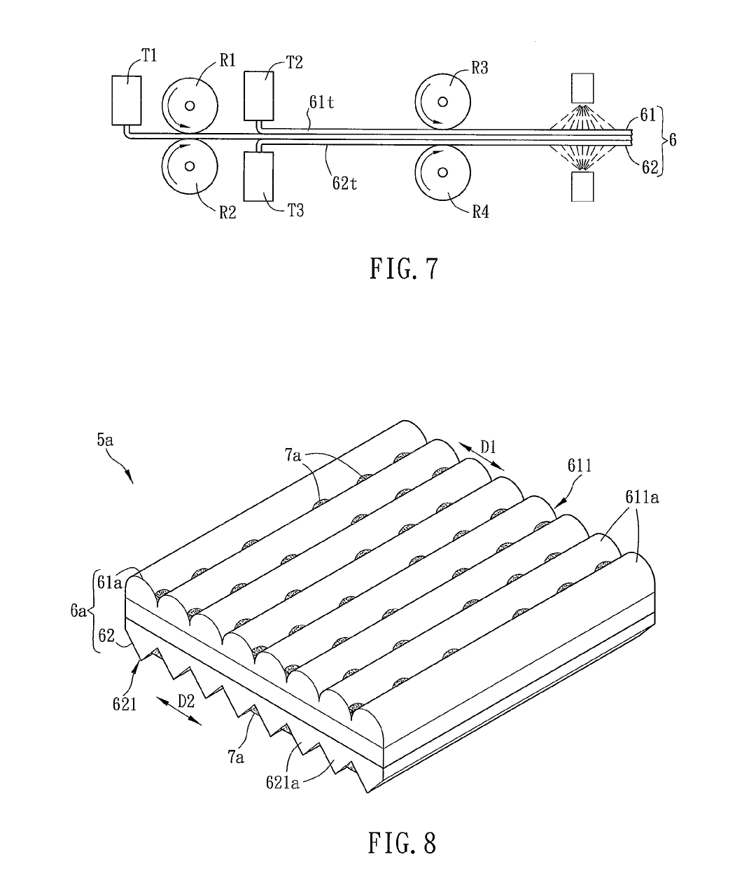

Hereinafter, the fabrication of the light guiding plate body 6 according to the second embodiment will be described with reference to FIG. 7.

First, the melted transparent polymer material is outputted from a tank T1 and then pressed by two planar rollers R1 and R2 for fabricating a plat plate. Next, the light-cured materials 61t and 62t are outputted from the tanks T2 and T3, respectively, and then disposed on the flat plate. Then, two embossed rollers R3 and R4 with predetermined concave pattern are used to press the light-cured materials 61t and 62t. After a curing process by irradiating UV light, the first surface 61 with the first microstructure array and the second surface 62 with the second microstructure array are fabricated.

To be noted, the difference between the refractive index of the transparent polymer material and the refractive index of the light-cured materials 61t and 62t is smaller than or equal to 0.03. In this embodiment, the refractive indexes of the light-cured materials 61t and 62t and the transparent polymer material are ranged between 1.49 and 1.52.

As mentioned above, the materials in tanks T2 and T3 are separately melted and then pressed by the rollers to form the first and second microstructure arrays 611 and 621, respectively, so that the first and second microstructure arrays 611 and 621 can be made of different materials. In addition, the light guiding plate body 6 can be fabricated in mass production by the rolling process in cooperating with two planar rollers R1 and R2 and two rollers R3 and R4 with predetermined concave patterns. After a proper cutting process, the desired light guiding plate body 6 can be manufactured.

### Third Embodiment

With reference to FIG. 8, the difference between the light guiding plate 5a of the third embodiment and the light guiding plate 5 of the second embodiment is in that the first direction D1 is in parallel to the second direction D2, and the total internal reflection destruction materials 7a are disposed on both of the first and second surfaces 61a and 62. In this embodiment, the lenticular lenses 611a of the first surface 61 are arranged in parallel along the first direction D1, and the prisms 621a of the second surface 62 are arranged in parallel along a first direction D2.

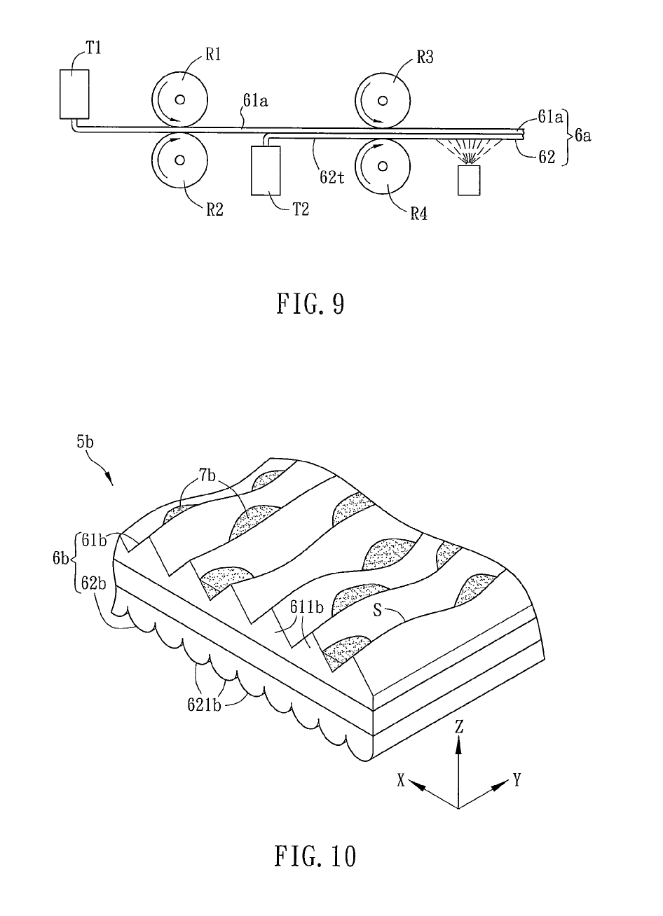

Hereinafter, the fabrication of the light guiding plate body 6a according to the third embodiment will be described with reference to FIG. 9.

First, the melted transparent polymer material is outputted from a tank T1 and then pressed by an embossed roller R1 with predetermined concave pattern and a planar roller R2 for forming the first microstructure array on the first surface 61. Next, the light-cured material 62t is outputted from the tank T2, and then pressed by a planar roller R3 and an embossed roller R4 with predetermined concave pattern. After a curing process by irradiating UV light, the second surface 62 with the second microstructure array is fabricated.

As mentioned above, the materials in tanks T1 and T2 are separately melted and then pressed by the rollers to form the first and second microstructure arrays, respectively, so that the first and second microstructure arrays can be made of different materials. After a proper cutting process, the desired light guiding plate body 6a can be manufactured.

### Fourth Embodiment

FIG. 10 is a schematic diagram of a light guiding plate 5b according to a fourth embodiment of the present invention. With reference to FIG. 10, the light guiding plate 5b includes a light guiding plate body 6b and a plurality of total internal reflection destruction materials 7b. In this case, the difference between the light guiding plate 5b of the fourth embodiment and the light guiding plate 5a of the third embodiment is in that the first microstructure array of the first surface 61b includes a plurality of prisms 611b, and the second microstructure array of the second surface 62b includes a plurality of lenticular lenses 621b. In this case, each prism 611b has a crest line that is a curved line S. The curved line S can be wabbled on the XY plane of the light guiding plate body 6b or waved on the Z direction thereof. In addition, the angles of the top corners of different prisms can be varied, but the top corners of different prisms 611b shown in FIG. 10 are the same for example.

As mentioned above, the light guiding plate of the present invention has a first surface with the first microstructure array, and the materials of the light guiding plate body and the total internal reflection destruction materials are different. Compared with the prior art, the light guiding plate body of the present invention can be manufactured by the rolling process, so that the cost for manufacturing machines and processes can be reduced. Moreover, the light guiding plate of the present invention can be easily fabricated in mass production. In addition, some of the total internal reflection destruction materials are light permeable, which facilitates the light refraction for forming the even surface light source.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light guiding plate, comprising:
a light guiding plate body having a first surface and a second surface opposite to the first surface, wherein the first surface has a first microstructure array; and
a plurality of total internal reflection destruction materials, which are different from the material of the light guiding body and are unevenly distributed on the first surface and/or the second surface.

2. The light guiding plate according to claim 1, wherein the light guiding plate body comprises two light-cured materials and a transparent polymer material, and the transparent polymer material is disposed between the light-cured materials.

3. The light guiding plate according to claim 2, wherein a difference between the refractive index of the light-cured materials and the refractive index of the transparent polymer material is smaller than or equal to 0.03.

4. The light guiding plate according to claim 2, wherein the refractive index of the light-cured materials and the refractive index of the transparent polymer material are ranged between 1.49 and 1.52.

5. The light guiding plate according to claim 1, wherein the first microstructure array comprises a plurality of lenticular lenses arranged in parallel along a first direction.

6. The light guiding plate according to claim 5, wherein the sections of the lenticular lenses are arc-shaped or semicircular respectively.

7. The light guiding plate according to claim 5, wherein each of the lenticular lenses has a top point, and a distance between two adjacent top points is ranged from 5 to 500 μm.

8. The light guiding plate according to claim 5, wherein each of the lenticular lenses has a height ranged from 5 to 500 μm.

9. The light guiding plate according to claim 1, wherein the second surface has a second microstructure array.

10. The light guiding plate according to claim 9, wherein the second microstructure array comprises a plurality of prisms arranged in parallel along a second direction.

11. The light guiding plate according to claim 10, wherein the sections of the prisms are triangular, trapezoid or irregular respectively.

12. The light guiding plate according to claim 10, wherein each of the prisms has a top corner, and a distance between two adjacent top corners is ranged from 5 to 500 μm.

13. The light guiding plate according to claim 10, wherein each of the prisms has a height ranged from 5 to 500 μm.

14. The light guiding plate according to claim 10, wherein each of the prisms has a crest line, and the crest line is a curved line.

15. The light guiding plate according to claim 10, wherein the first microstructure array and the second microstructure array are integrally formed.

16. The light guiding plate according to claim 5, wherein the second surface comprises a second microstructure array having a plurality of prisms, the prisms are arranged in parallel along a second direction, and the second direction is parallel to the first direction or forms an angle with the first direction.

17. The light guiding plate according to claim 1, wherein at least a part of the total internal reflection destruction materials are light permeable.

18. The light guiding plate according to claim 1, wherein each of the total internal reflection destruction materials comprises a plurality of scattering particles.

19. The light guiding plate according to claim 1, wherein the total internal reflection destruction materials are disposed on the first surface and/or the second surface by printing or ink-jet printing.
